(19) United States
(12) Patent Application Publication
(10) Pub. No.: US 2009/0165025 A1
(43) Pub. Date: Jun. 25, 2009

(54) Computer system architecture and operating method for the operating system thereof

(76) Inventors: Sheng Shun Yen, Chung Ho City (TW); Wei Shen, Chung Ho City (TW)

Correspondence Address: SINORICA, LLC, 2275 Research Blvd., Suite 500, ROCKVILLE, MD, 20850, US

(21) Appl. No.: 12/068,238

(22) Filed: Feb. 4, 2008

(30) Foreign Application Priority Data
Feb. 5, 2007 (TW) 096104024

(51) Int. Cl. G06F 9/44

(52) U.S. Cl. 719/327

(57) ABSTRACT

In order to develop a mobile operating system for a computer, first the mobile operating system must be independent from the computer hardware device. Therefore, the present invention discloses a new computer system architecture which loads a Transient Resident Operating System (TROS) from an external device and provides a predefined hardware device driver to the operating system, and then the TROS can be stored into a portable memory storage device to be a Mobile Operating System (MOS). By applying the technique disclosed in the present invention, the TROS can work beyond the Intrinsic Operating System (IOS) of the computer without the mutual interference from each other, such that a computer environment with a Parasitic Operating System (POS) is created.

### BACKGROUND OF THE INVENTION

1. Field of the Invention

The present invention relates to an operating method for an operating system in a computer. Wherein, the installation and relevant operations of the operating system are performed by the operating system based on the device driver messages provided by the computer. More particularly, the present invention provides a new computer system architecture, and in which a Parasitic Operating System (POS) environment is created underneath. The proposed computer architecture is different from the current computer architecture and mainly focuses on developing a Mobile Operating System (MOS).

2. Description of the Related Art

The current operating systems, including the time-sharing operating system, the parallel-running operating system, or the operating system for the personal desktop computers, all have to obtain the detail operating procedures for each computer hardware device, and the software component to perform this task is developed and provided by the hardware device vendors for each device based on various operating systems, this is the so-called device driver (or also know as driver). The operating system can normally operate the peripheral device only after the appropriate device driver is installed. Accordingly, since there are many kinds of hardware devices in the computer system, the objective of the Mobile Operating System (MOS) is hard to achieve. In the early ages, the users can use most of the computer functions through the MS-DOS operating system which is developed for the IBM-PC computer systems. Although the MS-DOS operating system has some mobile functions, it still heavily relied on the appropriate device drivers for its normal operations.

However, the current operating system is capable of time-shared multitasking and processing a great amount of data, such as the multimedia data with the cooperation of different peripheral devices based on various user requirements. Therefore, the current operating system is not good for mobile, and the computer is not available for the user until the operating system is installed into the hard disk drive (HDD).

### SUMMARY OF THE INVENTION

Therefore, it is an objective of the present invention to provide a computer hardware and software architecture for creating a proper platform to develop the Mobile Operating System (MOS). The computer architecture provided by the present invention helps the programmers to develop the Mobile Operating System (MOS) with various functions, and such MOS can be operated on various current operating systems, such as Windows XP, Windows 2000 and Windows Vista, etc.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a schematic computer system architecture diagram for Intel 975X chipset.

FIG. 2 is a schematic computer architecture block diagram of the present invention.

FIG. 3 is a schematic memory file system block diagram.

FIG. 4 is a schematic memory layer diagram.

FIG. 5 is a flow chart showing the implanting of the computer Transient Resident Operating System (TROS).

FIG. 6 is a flow chart showing the recovering of the computer Transient Resident Operating System (TROS).

FIG. 7 is a flow chart showing the computer power-on procedures.

### DETAILED DESCRIPTION OF THE PREFERRED EMBODIMENTS

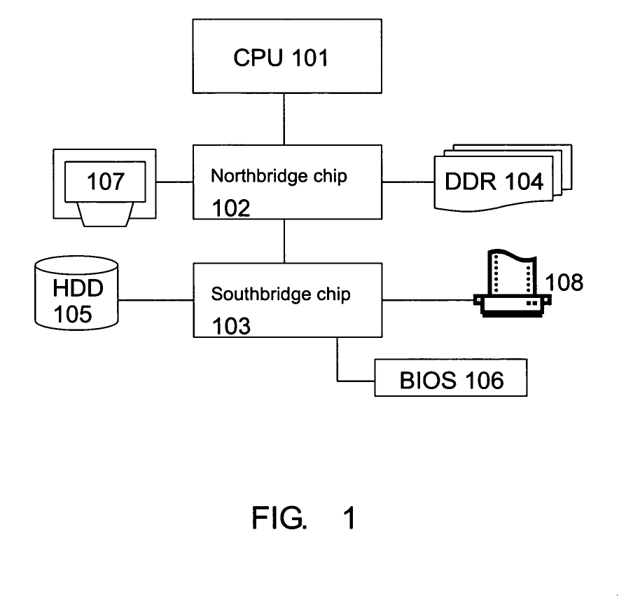

Using the Intel 975X computer architecture as an example for explanation, please refer to FIG. 1 that shows an architecture diagram for a computer system using the Intel 975X chipset as its core. The computer architecture mentioned above mainly comprises the following components: a CPU 101, a Northbridge chip (Intel 975) 102, a Southbridge chip (also known as the I/O Controller Hub (ICH)) 103, a main memory (DDR) 104, a Hard Disk Drive (HDD) 105, a Basic Input-Output System (BIOS) 106, a display 107, and an I/O device 108.

After the computer is powered on, the Basic Input-Output System (BIOS) 106 checks the CPU and the controllers, and then initializes the memory, the chipset of the motherboard, the display adapter, and all peripheral devices. Afterwards, the BIOS 106 loads the operating system sequentially from the HDD 105 to the DDR 104, and then the CPU 101 reads data from the DDR 104 to execute the operating system. After the operating system completes the loading of all hardware device drivers and the required software registration procedures, the control right is given back to the user and waits for the subsequent instruction from the user. The device drivers mentioned above must be installed when the user is installing the operating system the first time or when the user is adding an additional hardware device. In both cases, the operating system needs to be notified by the user to install the device driver. In other words, the operating system cannot install the device driver by itself automatically without notification from the user. Certainly, it is possible to perform the device driver automatic installation by using a pre-determined scheduling tool. However, it is not possible to automatically install the device driver for all hardware devices and especially for devices that we do not even know about yet. Moreover, when applying such computer architecture to develop a Mobile Operating System (MOS), unless the HDD operating method is re-specified, it is not possible to capture all device drivers that are originally resident on the computer directly from the operating system in the computer HDD 105, thus it is very hard to use such computer architecture to develop a Mobile Operating System (MOS).

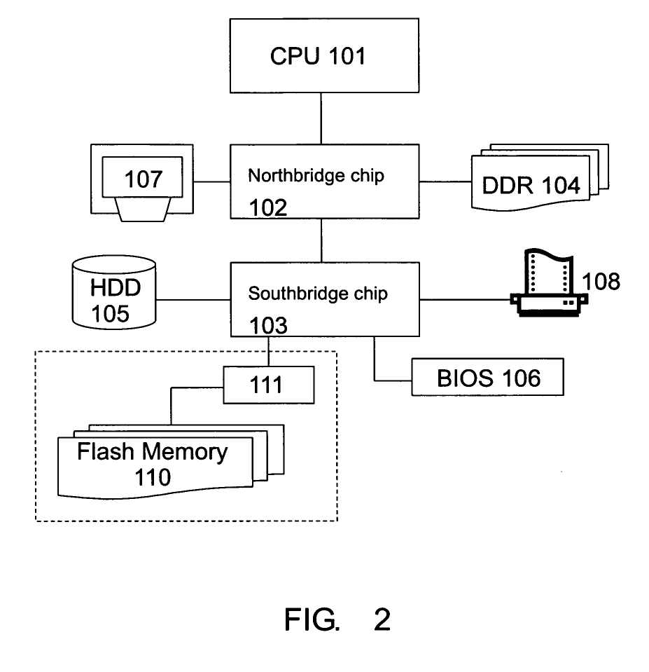

In order to resolve the problem mentioned above, the original computer architecture needs to be modified. Refer to FIG. 2, which schematically shows a computer system architecture provided by the present invention. FIG. 2 is mainly differed from FIG. 1 in that a Flash memory module 110 is added on the Southbridge chip 103, and a Flash memory controller 111 is further connected to the Flash memory module 110. Wherein, the Flash memory controller 111 does not only manage the data access of the Flash memory module 110, but is also responsible for command communication and necessary signal communication with the Southbridge chip 103. Of course, the Flash memory controller 111 may be integrated into the Southbridge chip 103 as a single piece in order to simplify the nonvolatile memory module design. Alternatively, the function of the Flash memory module may be performed by using the nonvolatile memory module with different technology, for example, the Phase Change Random Access Memory (PCRAM), etc. In fact, this is a true nonvolatile memory module 110, and since we would like to avoid a lengthy explanation for convenient reading purposes, the Flash memory module is exemplified hereinafter in FIG. 2 and the further context for explanation.

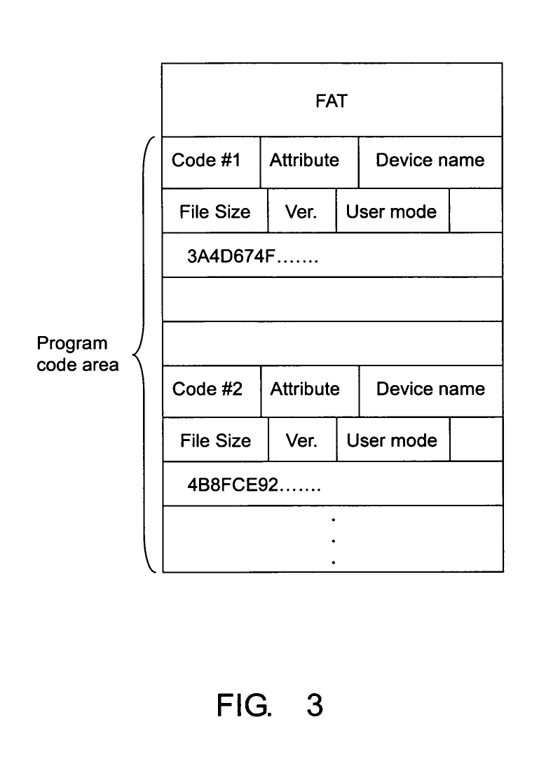

The main function of the Flash memory module 110 is for loading and storing the device drivers of all hardware devices in the computer, such that the computer architecture can provide a Transient Resident Operating System (TROS) to fetch the device drivers of all hardware devices in the computer, and the TROS can correctly execute the operations for all hardware peripheral devices of the computer. In order to help the TROS to effectively and correctly fetch the device drivers, a file system is required to properly manage the data in the Flash memory module 110, such that the TROS can quickly install the required resources based on the operating conditions. FIG. 3 schematically shows an example of a file system, in which the type of device driver, the corresponding hardware device, the program size, the version record, the user mode, the program starting address, and the program code area are recorded in the file system. These data are respectively stored in the pre-defined memory areas, and these areas include a File Allocation Table (FAT) and program code areas, etc. The specification mentioned above is the standard specification defined by the industry. Therefore, the TROS can quickly and effectively install the required device drivers based on the contents of the file system.

The Flash memory controller 111 in FIG. 2 does not only perform the protocol operation of the interface signal and reply to the chipset operation, but is also responsible for the following tasks:

1. Processing and planning the management of the memory blocks inside the memory.

2. Distributing the appropriate memory area location for storing and reading data based on the content of the file system mentioned above.

Wherein, the first task sustains the reliability of the memory unit and the lifetime of the memory module; and the second task increases the effectiveness of the data utilization. This technique is different from the current PROM technique that is applied on the motherboard for storing the BIOS.

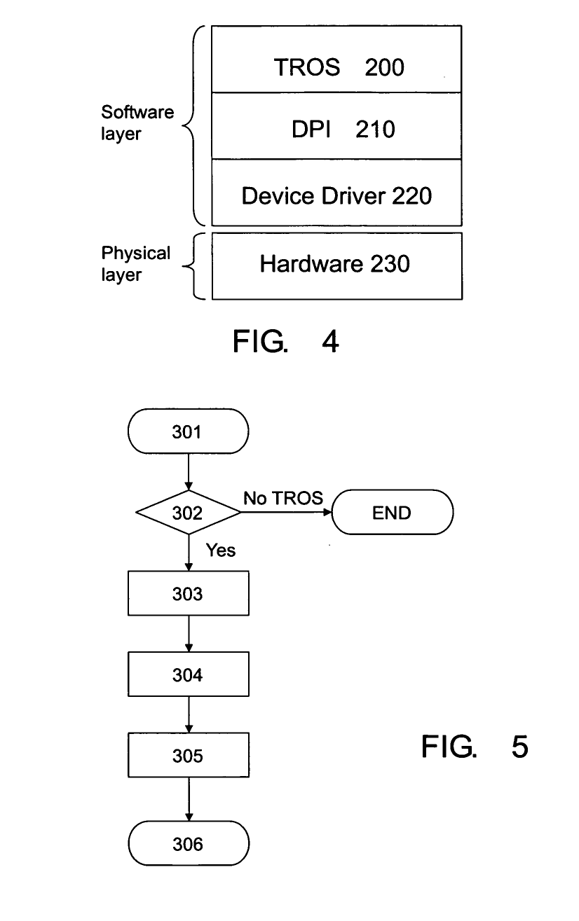

In addition, to consider the compatibility of future various TROS to the device drivers, a uniform software layer interface between the device driver and the TROS has to be defined. Please refer to FIG. 4, which schematically shows a software layer diagram. The registration and implanting operation of the device driver 220 is performed by the TROS 200 through a Driver Programming Interface (DPI) 210. Wherein, the DPI 210 may be treated as one portion of the Software Development Kit (SDK). Moreover, when compared to the conventional SDK, the DPI 210 differs mainly in that it is used for developing a low level device driver of the hardware device rather than for developing a high level application that runs on top of the operating system. Therefore, the programmer who writes the device driver does not need to deal with the detailed design of various TROS that is developed for performing the specific objective on the current market. Instead, the programmer only needs to obtain the DPI from the TROS to develop the device driver. As a result, it is possible for the programmer to quickly develop the device driver. Similarly, the TROS development engineer dose not need to worry about so many computer peripheral devices and their related device drivers that exist on the current market. Instead, the TROS development engineer only needs to focus on the standard DPI software planning and write appropriate interface service program for the driver planning. Accordingly, the input of the TROS development and design is simplified, and the compatibility between the TROS and the device drivers are still sustained.

The searching and loading device driver issues for the TROS is resolved by applying the method mentioned above. However, it is to be noted that the device driver developed by using the DPI is not necessary the same as the device driver of the Intrinsic Operating System (IOS) that was originally installed in the computer.

Therefore, the present invention provides a computer architecture that is specially designed for the nonvolatile memory module, the nonvolatile memory module 110 is used as a memory media to store the driver of the devices inside the computer. In comparison with the current computer architecture, refer to FIG. 1, since the computer shown in FIG. 1 lacks a nonvolatile memory module, the device driver can be only stored in the hard disk driver that also has the nonvolatile memory characteristic. However, this computer architecture provides an opportunity for the TROS to intrude the Intrinsic Operating System (IOS) originally installed in the HDD 105 and open a back door for the security management. Therefore, this is surely not the best solution. Moreover, the computer architecture provided by the present invention can fully deploy the characteristics of the nonvolatile memory module to develop various applications, and the computer architecture is characterized in:

1. Providing an operating environment where the circuit system is independent from the HDD 105;

2. Sustaining the data in the memory even when the power is off;

3. Not occupying the resource of the DDR 104; and

4. Using the Flash memory controller to store data and manage the memory blocks.

Therefore, storing the device driver of the hardware devices is not the only task for the nonvolatile memory module 110, both the computer operating system developer and the application programmer can utilize the nonvolatile memory module 110 to develop the program for specific function.

However, in order to provide the mobility for the developed TROS, an external mobile storage device is further required. Besides using the conventional optical or floppy disk, if it is also required to encrypt the data and process the instructions sent from the host, a storage device with a memory controller is a preferable choice. Therefore, the current USB portable disk widely accepted by the users can be used. Here, the USB portable disk is a nonvolatile memory data storage device that comprises a memory controller and uses the USB standard as its interface, thus it totally fulfills the design requirement mentioned above. In addition, if the compact size of mobile storage device is further considered, the nonvolatile memory card that complies with the Intelligent Stick interface and its operating specification will be also applicable. Besides having the MMS interface, the nonvolatile memory card with Intelligent Stick interface also has USB interface function for connecting to the standard USB interface, thus the Intelligent Stick is a better solution in comparison with the conventional USB nonvolatile memory data storage device. Certainly, the choice of the operating interface may be versatile, for example, the storage device with high speed interface widely applied on the current computer platform, such as PCI Express, SATA, IEEE 1394 interface, also can be used as a storage device to develop the aforementioned Mobile Operating System (MOS), here the PCI Express Card is a good example. For other memory cards, including the SD card, MMC card, and micro SD card that are widely used in multimedia electronic devices such as digital camera and mobile phone, since it is not the standard interface used in the conventional computer platform, it is not suitable to be used as the storage device for the computer's Mobile Operating System (MOS) before its specification is integrated into the computer platform interface standard by the industry.

FIG. 5 is a flow chart showing the implanting of the computer Transient Resident Operating System (TROS). First, in step 301, the host detects an external storage media connection (301). Then, in step 302, the CPU checks whether the TROS is stored in the storage media. In step 303, if the TROS is stored in the storage media, an interrupt procedure is performed to interrupt some unnecessary processes, namely the processes for all other unnecessary peripheral devices except for mandatory devices such as the display adapter are all cleared, and the data of the Intrinsic Operating System (IOS) in the main memory (DDR) is released to the Flash memory module 110 or the hard disk driver (HDD). Wherein, a certain percentage of the main memory area is released to be a Free-load memory zone based on the requirements of the TROS and IOS, and a portion of the Free-load memory zone is reserved for the “Memory zone for recovery” function. In step 304, the original memory internal data and the corresponding cache and flag data inside the CPU are temporarily saved in the Flash memory module 110 or the HDD 105 of the computer, and then the TROS is loaded into the Free-load memory zone. In step 305, a recovery program is loaded into the “Memory zone for recovery” area mentioned above, wherein the recovery program is provided by the TROS or IOS. Then, the CPU performs the device driver loading process requested by the TROS. In step 306, after the device driver is completely loaded from the nonvolatile memory module 110, the TROS returns the usage right to the user and the system enters into standby mode. Meanwhile, the computer operating system is fully transferred to the TROS, and the user can use this computer to perform his/her own operating system and applications. Moreover, since all device divers are already correctly installed by the TROS, the user can easily uses various peripheral devices connected to the computer, such as the display adapter, the sound card, the printer, and the network adapter, etc. Therefore, this system design facilitates the user in carrying the operating system and data by using the compact size storage media, which significantly reduces the frequency of carrying the notebook computer and also sustains the computer hardware environment which is equal to or better than the notebook computer.

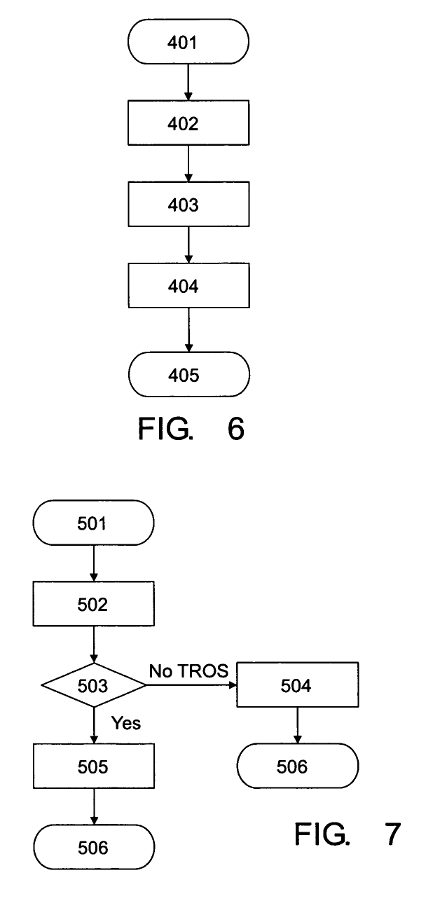

FIG. 6 is a flow chart showing the recovering of the computer Transient Resident Operating System (TROS). First, in step 401, the TROS is removed. Then, in step 402, the CPU executes the operating system recovery program that is stored in the “Memory zone for recovery” area of the main memory (DDR) and clear the data stored on the main memory by the TROS. Then, in step 403, the data originally stored in the Flash memory module or the HDD of the computer are reloaded into the main memory to complete the main memory data recovery task. In step 404, after the recovery is completed, the CPU executes the IOS and recovers the original state of each register, and then recalls and checks all peripheral devices. Finally, in step 405, the control right is given back to the IOS. At this moment, the system is recovered to the state that it was in before the TROS took over the computer system, and the system enters into standby mode and waits for the next user.

In summary, the present invention discloses a computer architecture and an operating method applying the same. Under such computer architecture, an external temporary operating system is accepted by the computer even if the original operating system is still running, and the control right of the computer is temporarily given to this temporary operating system. Here, the former operating system is called as the Intrinsic Operating System (IOS), and the latter temporary operating system is called as the Transient Resident Operating System (TROS). In the power-on process of such computer architecture, the power-on task can be directly performed by the TROS, and the TROS will not necessarily be activated by the IOS, which increases the flexibility of the TROS. In addition, if the TROS is designed for specific functions, such as conference presentation, email/MSN, VOIP network phone, and remote security monitoring, etc, as long as the TROS is properly designed, the TROS can effectively utilize the computer device without having to use unnecessary system resources such as the flowery 3D window display which requires mass memory processing. In comparison with the IOS, the present invention does not only provide a faster computer and data processing speed, but also a shorter power-on time. Accordingly, the present invention provides a Parasitic Operating System (POS) operating concept which is formed by the TROS, thus provides more versatile choices in selecting the operating system products and also satisfies the higher operating efficiency requirement for the customers.

FIG. 7 is a flow chart showing the computer power-on procedures, wherein the computer power-on task is performed by the TROS. First, in step 501, the power is turned on. Then, in step 502, the BIOS checks all hardware devices. In step 503, it is to determine whether the TROS for the power-on task is stored in the external storage device. If there is no TROS in the external storage device, the power-on task is performed by the IOS in the computer (step 504), so as to complete the computer power-on task (step 506). Otherwise, if it is detected that the TROS is stored in the external storage device, the power-on procedures are directly activated by the TROS (step 505), and the device driver is obtained from the nonvolatile memory 110 and loaded into the computer, so as to complete the computer power-on task (step 506). This method is similar to the one used in the MS-DOS operating system which is stored in the floppy disk. The difference between this method and the one used in the MS-DOS is the TROS will load the device drivers for all peripheral devices from the computer system and complete the computer power-on task. Along with the prevalence of the hard disk drive (HDD), the MS-DOS had been installed in the HDD accompanying with the device drivers to perform the computer power-on procedures. However, as described previously, in such case the mobility of the operating system is also lost. With the help of the continuously developed functions for the operating system, the portable notebook computer is widely accepted and had become a mandatory computing facility for the users. The major reason for this is the operating system and the computer hardware had been integrated into a single piece, such that the user needs to carry the computer hardware and the software at the same time in order to accomplish the tasks.

Therefore, by using the computer hardware architecture shown in FIG. 2 and in cooperation with the software operating procedures and the aforementioned software interface specification in FIG. 5-7, it is possible to provide an operating concept for the Parasitic Operating System (POS) and a development blueprint applying the same. By implementing the concept of the Parasitic Operating System (POS) and Transient Resident Operating System (TROS), the user does not need to carry the notebook computer and its complicated operating system that is designed for the desktop computer, such as the Windows Vista. Therefore, the present invention also open a new market business opportunity for developing a micro operating system that is capable of providing various powerful functions without using the conventional technique used in the traditional computer system design, thus it is innovative in both the design concept and technique implementation.

Refer to FIG. 2 again, wherein the HDD can be embodied by a Hybrid HDD in which the Flash memory component is added into the mechanical hard disk drive (HDD). Referring to the step 304 in FIG. 5, by applying such Hybrid HDD in the computer architecture of the present invention, the key information stored in the CPU, such as the flag value and the register value may be saved in the Flash memory inside the HDD. Therefore, the operating system switching speed and efficiency are both improved.

Accompanying with the continuous progress of the semiconductor techniques, as the read/write speed of the Flash memory reaches the high speed requirement, the Flash memory module and the memory controller shown on FIG. 2 may be further connected to the Northbridge chip 102, so as to improve the data communication speed and efficiency between the Flash memory module and the main memory (DDR) 104. Certainly, the memory controller chip may be integrated into the Northbridge chip 102 by applying the semiconductor integration technique. For simplifying the memory controller chip design, the ONFI specification co-defined by Intel, Hynix and Sony Companies can be used for the design, wherein the ONFI is the abbreviation of Open NAND Flash Interface.

In the computer hardware architecture and the software program provided by the present invention, both the IOS and the TROS that works as the POS are time independent operating systems, thus they will not interfere with each other. In consideration of the information security on both sides, the user authentication must be performed under certain security mechanism, and the necessary data security facilities must be appropriately applied. Here, the data security mechanism can be implemented through the proper design of the whole system.

In summary, in order to successfully develop a Mobile Operating System (MOS), the original obstacle existed on the conventional computer architecture has to be overcome first, then the software program control should be also properly re-programmed. The present invention concentrates on the development and improvement of the technique with the aforementioned characteristics, and finally discloses a brand new computer hardware architecture and a software operating method applying the same. The author of the present invention had dedicated many years in the computer operating system technology development, and finally discloses an innovative concept of applying the Parasitic Operating System (POS) and the Transient Resident Operating System (TROS) to resolve the aforementioned issue in the present invention.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. An operating method for a Transient Resident Operating System (TROS) of a computer platform, wherein said operating method comprises: connecting said operating system to said computer platform from an external memory device through an appropriate operating interface; interrupting a plurality of tasks for a plurality of peripheral devices and clearing the data after said operating system is detected by said computer platform; re-planning a main memory space of said computer into a plurality of memory blocks; moving and storing the data that is originally stored in said planned memory blocks into a nonvolatile memory unit inside said computer, such that said operating system can be loaded into said main memory blocks; loading said operating system into said main memory blocks that had been emptied; said CPU of said computer executing said operating system in said main memory blocks, and reading and loading a device driver of said computer from said nonvolatile memory unit inside said computer; using a software program provided by said operating system to register and confirm said device driver; and finally said computer and said operating system giving a usage right to a user, and entering into a standby mode.

2. The operating method for the Transient Resident Operating System (TROS) of the computer platform of claim 1, wherein said operating method further comprises a standard Driver Programming Interface (DPI) that works as a standard programming operation specification between said device driver and said operating system, and comprises a software interface specification and program I/O protocol and method between said device driver and said operating system, such that said device driver can be loaded into said operating system and said main memory of said computer for providing a software program to operate said computer.

3. The operating method for the Transient Resident Operating System (TROS) of the computer platform of claim 1, wherein said nonvolatile memory unit inside said computer is appropriately planed and divided into a plurality of zones, and the data is stored and recorded based on different attributes, so as to form a file manage structure.

4. The operating method for the Transient Resident Operating System (TROS) of the computer platform of claim 2, wherein said nonvolatile memory unit inside said computer is appropriately planed and divided into a plurality of zones, and the data is stored and recorded based on different attributes, so as to form a file manage structure.

5. An operating method for recovering a Transient Resident Operating System (TROS) from a computer, wherein said operating method comprises: first, after said operating system is released from said computer, said computer uses a recovery program to load another operating system into a main memory from a hard disk drive (HDD) or a nonvolatile memory and checks a plurality of peripheral devices, and then enters into a standby mode of said another operating system.

6. The operating method for recovering the Transient Resident Operating System (TROS) from the computer of claim 5, wherein said recovery program is provided by said Transient Resident Operating System (TROS).

7. The operating method for recovering the Transient Resident Operating System (TROS) from the computer of claim 5, wherein said recovery program is provided by said another operating system.

8. An operating method used by an operating system to power on a computer, wherein said operating method comprises: after said computer is powered on, said computer checks a plurality of hardware devices, and then loads said operating system into a main memory of said computer from an external memory device through a chipset of said computer; then a CPU of said computer executes said operating system that is stored in said main memory; specifically, said operating system reads and loads a device diver for said hardware device of said computer from a nonvolatile memory unit inside said computer, and uses a software program provided by said operating system to register and confirm said device driver; and finally said computer and said operating system enter into a standby mode for completing a power-on process of said computer.

9. The operating method used by the operating system to power on the computer of claim 8, wherein said operating method further comprises a standard Driver Programming Interface (DPI) that works as a standard programming operation specification between said device driver and said operating system, and said DPI further comprises a software interface specification and program I/O protocol and method between said device driver and said operating system, such that said device driver can be loaded into said operating system and said main memory of said computer for providing a software program to power on and operate said computer.

10. The operating method used by the operating system to power on the computer of claim 8, wherein said nonvolatile memory unit inside said computer is appropriately planed and divided into a plurality of zones, and the data is stored and recorded based on different attributes, so as to form a file manage structure.

11. The operating method used by the operating system to power on the computer of claim 9, wherein said nonvolatile memory unit inside said computer is appropriately planed and divided into a plurality of zones, and the data is stored and recorded based on different attributes, so as to form a file manage structure.
